(19) United States
(12) Patent Application Publication
(10) Pub. No.: US 2016/0157097 A1
(43) Pub. Date: Jun. 2, 2016

(54) METHOD AND APPARATUS FOR SECURE ACCESS TO ACCESS DEVICES

(71) Applicant: THOMSON LICENSING, Issy-les-Moulineaux (FR)

(72) Inventor: Casimir Johan CRAWLEY, Carmel (IN)

(73) Assignee: THOMSON LICENSING, Issy les Moulineaux (FR)

(21) Appl. No.: 14/907,071

(22) PCT Filed: Jul. 24, 2013
(86) PCT No.: PCT/US13/51841

§ 371 Date: Jan. 22, 2016

(51) Int. Cl. H04W 12/06; H04L 29/06

(52) U.S. Cl. CPC H04W 12/06; H04L 63/0876; H04L 63/101

(57) ABSTRACT

A method and apparatus for providing secure access to a wireless station (12) to an access device (60) and network is provided. Upon initial activation, a wireless gateway/set-top-box (60) is configured to enable an isolated web server (72) and to enable insecure access point authentication. Once enabling has been performed, a detected wireless station (12) can be authenticated and associated with the wireless gateway/set-top-box (60) by revealing the MAC address of the wireless station (12), for example, to an administrator. If the MAC address is accepted, the MAC address is stored in a MAC address filter list of the wireless gateway/set-top-box (60). The wireless station (2) is de-authenticated and disassociated with the wireless gateway/set-top-box (60) and the isolated web server (72) and insecure access point authentication is disabled. Secure access point authentication for the wireless station (12) can then begin.

### BACKGROUND OF THE INVENTION

1. Technical Field

The present principles relate to access devices and more particularly to a method and apparatus for secure access to a wireless gateway device.

2. Related Art

Consumer wireless gateways (WG's) and access points (AP's) currently offer security using Medium Access Control (MAC)-level authentication like address filtering or Wired Equivalent Privacy (WEP). Such devices may also offer link-level authentication like Wi-Fi Protected Access (WPA). Authentication security can be improved by combining MAC address filtering with WEP or WPA. However, updating filter lists with MAC addresses can be a tedious and error-prone activity for household WG and AP administrators. In addition, MAC addresses are also esoterically managed and obscured by wireless device operating systems, thus avoiding possible consumer confusion in managing the same.

### SUMMARY OF THE INVENTION

Embodiments of the present invention address these and other deficiencies of the prior art by providing a method and apparatus by which administrators of access devices such as wireless gateway/set-top box (WG/STB) devices can conveniently discover Medium Access Control (MAC) addresses by temporarily enabling insecure authentication and interaction with an isolated web server. The device then reverts back to its secure authentication and operational web server after administrator MAC address confirmation. Access security is thus improved in accordance with various embodiments of the present invention by combining MAC address filtering and authentication.

In one embodiment of the present invention, a method includes enabling an isolated web server and insecure access point authentication in an access device, authenticating and associating a wireless station to be connected to the access device, displaying a MAC address of the wireless station and accepting or rejecting the displayed MAC address.

In an alternate embodiment of the present invention, an access device includes a processor, a memory in communication with the processor and a wireless interface in communication with the processor and configured to enable wireless communication with external devices. In such an embodiment, the access device is configured to enable an isolated web server and insecure access point authentication, authenticate and associate a wireless station to be connected to the access device, display a MAC address of the wireless station to an administrator and accept or reject the displayed MAC address.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an access device in accordance with an embodiment of the present invention; and

FIG. 2 depicts a flow diagram of a method for secure access to an access device in accordance with an embodiment of the present invention.

### DETAILED DESCRIPTION

Embodiments of the present invention advantageously provide a method and apparatus for enabling secure access to access devices. Although the present invention will be described primarily within the context of wireless gateway devices and set-top boxes, the specific embodiments of the present invention should not be treated as limiting the scope of the invention. It will be appreciated by those skilled in the art and informed by the teachings of the present invention that the concepts of the present invention can be advantageously applied to any access devices.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

Furthermore, because some of the constituent system components and methods depicted in the accompanying drawings can be implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

Updating filter lists with MAC addresses can be a tedious activity for household wireless gateway (WG) and access point (AP) administrators. MAC addresses are esoteric and obscured by wireless device operating systems, thus avoiding possible consumer confusion. Embodiments of the present invention are directed to authentication in wireless gateway/set-top-boxes (WG/STB) and more specifically, embodiments of the present invention provide a method by which novice consumers can securely yet conveniently update MAC addresses in their WG/STB devices. In one embodiment of the present invention, WG/STB device administrators are able to conveniently discover Medium Access Control (MAC) addresses by temporarily enabling insecure authentication and interaction with an isolated web server. The WG/STB device of the present invention then reverts back to a secure authentication and operational web server after MAC address confirmation. Access security is thus improved by combining MAC address filtering and authentication in accordance with the described embodiments of the present invention, herein.

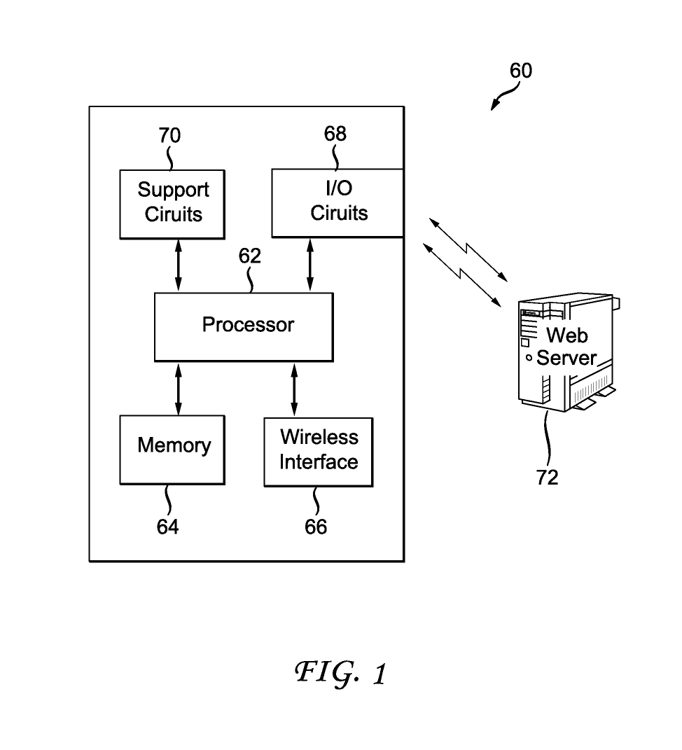

FIG. 1 depicts a high level block diagram of an access device in accordance with an embodiment of the present invention. As depicted in FIG. 1, a gateway device 60 of an embodiment of the present invention illustratively includes a processor 62 in communication with various internal components such as a memory 64, a wireless interface/station 66 and other internal support circuits 70. The memory 64 can include any suitable memory, such as, for example, RAM, DRAM, a hard disk drive storage device, a solid state storage device, etc. The wireless interface 66 can include any suitable interface capable of operating with one or more wireless communication protocols. In the gateway device 60 of FIG. 1, one or more I/O circuits 68 (e.g., USB, Ethernet, etc.), also connected to the processor 62 provide some external communication capability to the gateway device. In FIG. 1, a web server 72 is in communication with the wireless gateway device 60 and is utilized in the secure access method of the present principles. In the embodiment of FIG. 1, the web server 72 operates in normal mode or in isolation mode under an administrator's control in accordance with embodiments of the present invention. In normal mode, the web server 72 accepts and processes incoming access requests (e.g., http requests) normally. In one embodiment of the present invention, in isolation mode, the web server 72 accepts and processes only administrator session requests while rejecting all other incoming requests. In isolation mode, the administrator can use a browser of an external personal computer or a browser embedded in the wireless gateway/set-top box.

Although the wireless gateway device 60 of FIG. 1 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

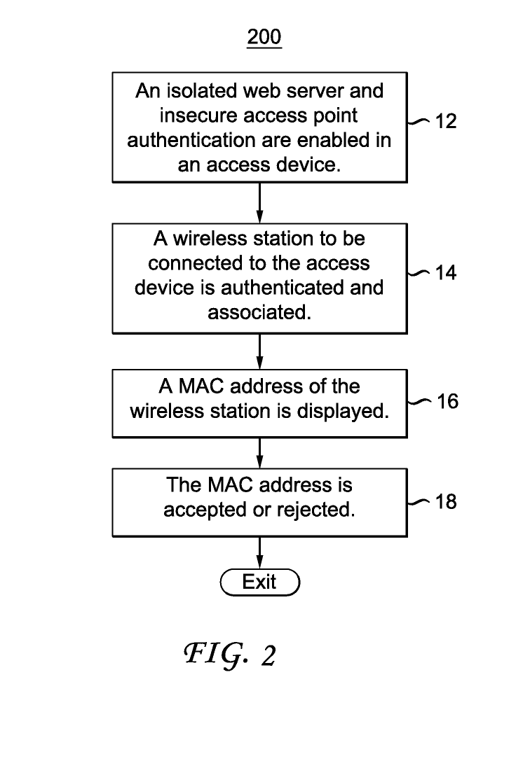

FIG. 2 depicts a flow diagram of a method for secure access to an access device capable of being implemented by the wireless gateway device 60 of FIG. 1 in accordance with an embodiment of the present invention. The method 200 begins at step 12 during which the wireless gateway device 60 enables an isolated web server. The web server provides security by preventing any access outside its execution environment including internet or vulnerable host resources. The wireless gateway device 60 also enables insecure authentication at step 12 by disabling WEP or WPA challenges. The method 200 then proceeds to step 14.

At step 14, once the insecure authentication is enabled, the wireless gateway device 60 obtains a desired MAC address by authenticating and associating a desired wireless station such as the wireless interface/station 66 of FIG. 1. It should be noted that the wireless station described herein can include any component enabling connection to a wireless medium. The method 200 then proceeds to step 16.

At step 16, the MAC address of the wireless gateway device 60 is displayed on a display device such as a connected television or display device from which the MAC address can be observed by an administrator. The method 200 then proceeds to step 18.

At step 18, the MAC address is either accepted or rejected. In one embodiment of the present invention, the MAC address is either accepted or rejected manually by an administrator using an input device like a remote control. In one embodiment of the present invention, if the MAC address is rejected, the wireless gateway device 60 de-authenticates and disassociates the wireless station 66, disables the isolated web server and insecure AP authentication, re-enables the secure AP authentication, and finally terminates the operation.

In an alternate embodiment of the present invention, if the MAC address is accepted, the wireless gateway device 60 stores the MAC address in a MAC Filter list, de-authenticates and disassociates the station, disables the isolated web server and insecure AP authentication, and enables its conventional AP authentication using WEP or WPA keys.

That is, the wireless gateway device 60 attempts the station key authentication using the wired equivalent privacy (WEP) key or wi-fi protected access (WPA) key. If the wireless station fails authentication using the shared WEP or WPA key, then the operation terminates. If the station passes authentication using the shared WEP or WPA key, then the wireless gateway device 60 attempts association using the station's MAC address. A determination is then made whether the station's MAC address appears in the MAC address filter list of the wireless gateway device 60. If yes, then the wireless gateway device 60 associates the station, thus allowing normal network access. If the station's MAC address is missing from the MAC address filter list of the wireless gateway device 60 at determination, then the wireless gateway device 60 de-authenticates the station thus preventing normal network access.

Having described various embodiments of a method and apparatus for enabling secure access to access devices (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method comprising the steps of:
enabling an isolated web server and insecure access point authentication in an access device;
authenticating and associating a wireless station to be connected to the access device;
displaying a MAC address of the wireless station; and
accepting or rejecting the displayed MAC address.

2. The method of claim 1, comprising the steps of:
rejecting the displayed MAC address;
deauthenticating and disassociating the wireless station;
disabling an isolated web server and insecure access point authentication in the access device; and
enabling secure access point authentication.

3. The method of claim 1, comprising the steps of:
accepting the displayed MAC address for the wireless station; and
storing the wireless station MAC address in a MAC Address filter list.

4. The method of claim 3, further comprising the steps of:
de-authenticating and disassociating the wireless station;
disabling the isolated web server and insecure access point authentication in the access device;
enabling secure access point authentication;
attempting station key authentication of the wireless station; and
determining whether the access device can authenticate the station key.

5. The method of claim 4, comprising the steps of:
attempting MAC address association when the access device has authenticated the station key;
determining whether the attempted MAC address association is successful; and
associating the wireless station when the attempted MAC Address association is successful.

6. The method of claim 4, comprising the steps of:
attempting MAC address association when the access device has authenticated the station key;
determining whether the attempted MAC address association is successful; and
de-authenticating the wireless station when the attempted MAC address association is unsuccessful.

7. The method of claim 4, wherein said attempting station key authentication comprises use of one of wired equivalency privacy shared key or Wi-Fi protected access pre-shared key.

8. The method of claim 1, wherein said enabling comprises disabling at least one of wired equivalency privacy key and Wi-Fi protected access key challenges to the access device.

9. An access device, comprising:
a processor;
a memory in communication with the processor; and
a wireless interface in communication with the processor and configured to enable wireless communication with external devices;
the access device configured to:
enable an isolated web server and insecure access point authentication;
authenticate and associate a wireless station to be connected to the access device;
display a MAC address of the wireless station to an administrator; and
accept or reject the displayed MAC address.

10. The access device of claim 9, wherein the access device is configured to:
reject the displayed MAC address;
de-authenticate and disassociate the wireless station;
disable the isolated web server and insecure access point authentication; and
enable secure access point authentication.

11. The access device of claim 9, wherein the access device is configured to:
accept the displayed MAC address for the wireless station; and
store the wireless station MAC address in a MAC Address filter list.

12. The access device of claim 11, wherein the access device is configured to:
de-authenticate and disassociate the wireless station;
disable the isolated web server and insecure access point authentication;
enable secure access point authentication;
attempt station key authentication of the wireless station; and
determine whether station key authentication is successful.

13. The access device of claim 11, wherein the access device is configured to:
attempt MAC address association when station key authentication is successful;
determine whether the attempted MAC address association is successful; and
associate the wireless station when the attempted MAC Address association is successful.

14. The access device of claim 11, wherein the access device is configured to:
attempt MAC address association when station key authentication is successful;
determine whether the attempted MAC address association is successful; and
de-authenticate the wireless station when the attempted MAC address association is unsuccessful.

15. The access device of claim 11, wherein the attempt for station key authentication comprises use of one of wired equivalency privacy shared key or Wi-Fi protected access pre-shared key.

16. The access device of claim 9, wherein the access device is configured to disable at least one of wired equivalency privacy key and Wi-Fi protected access key challenges during the enabling of the isolated web server and insecure access point authentication.
